(19) United States
(12) Patent Application Publication
(10) Pub. No.: US 2025/0277393 A1
(43) Pub. Date: Sep. 4, 2025

(54) GLOVE BOX MANAGEMENT

(71) Applicant: Rivian IP Holdings, LLC, Irvine, CA (US)

(72) Inventors: Caleb Alexander WESTHOLDER, Laguna Beach, CA (US); William Kirk ROBINSON, Newport Beach, CA (US); Robert SKAPOF, Coto De Caza, CA (US); Shukan Shitalkumar PAREKH, Costa Mesa, CA (US); Cecilia Kouthoofd WEBER, Costa Mesa, CA (US); Kostandinos PAPANIKOLAOU, Corona, CA (US); Suhant RANGA, Novi, MI (US)

(21) Appl. No.: 19/065,940

(22) Filed: Feb. 27, 2025

Related U.S. Application Data
(60) Provisional application No. 63/560,596, filed on Mar. 1, 2024.

(51) Int. Cl. E05B 81/62; E05B 81/16; E05B 81/70; E05B 83/30

(52) U.S. Cl. CPC E05B 81/62; E05B 81/16; E05B 81/70; E05B 83/30

(57) ABSTRACT

A container management system can use an electronic push-push interface to facilitate transition of the container in response to user inputs. Switches can be provided to detect the container position, and an actively controlled latch can respond to the detected position to lock or unlock the container. The display can also be operated to control the configuration of the container. The management system can also perform controls based on one or more other detectable conditions, such as locking the container when one or more external events are detected.

### CROSS REFERENCE TO RELATED APPLICATIONS

This application claims the benefit of priority to U.S. Provisional Patent Application No. 63/560,596, entitled, “GLOVE BOX MANAGEMENT”, filed on Mar. 1, 2024, the disclosure of which is hereby incorporated herein in its entirety.

### INTRODUCTION

The present description relates generally to vehicles. More particularly, the present disclosure relates to management systems for a glove box and other containers of vehicles. Vehicles are often provided with a glove box and/or other containers to provide a stowable space for storing one or more items therein.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a schematic perspective side view of an example implementation of a vehicle having a dashboard in accordance with one or more implementations.

FIG. 2 illustrates a perspective view of an example implementation of a dashboard for a vehicle having containers in a closed configuration in accordance with one or more implementations.

FIG. 3 illustrates a perspective view of an example implementation of the dashboard of FIG. 2 having containers in an open configuration in accordance with one or more implementations.

FIG. 4 illustrates a top view of an example implementation of a container system in accordance with one or more implementations.

FIG. 5 illustrates a perspective view of an example implementation of containers for a vehicle in accordance with one or more implementations.

FIG. 6 illustrates a side sectional view of an example implementation of a container in an open configuration in accordance with one or more implementations.

FIG. 7 illustrates a side sectional view of an example implementation of the container of FIG. 6 in an overtravel configuration in accordance with one or more implementations.

FIG. 8 illustrates a side sectional view of an example implementation of the container of FIGS. 6 and 7 in a closed configuration in accordance with one or more implementations.

FIG. 9 illustrates a schematic view of an example implementation of a locking system for controllably securing and releasing a container in accordance with one or more implementations.

FIG. 10 illustrates a schematic view of an example implementation of a portion of the locking system of FIG. 9 with the latches in an unlocked configuration in accordance with one or more implementations.

FIG. 11 illustrates a schematic view of an example implementation of the locking system of FIG. 10 with the latches in an unlocked configuration in accordance with one or more implementations.

FIG. 12 illustrates a schematic view of an example implementation of a portion of the locking system of FIGS. 10 and 11 with the latches in an unlocked configuration in accordance with one or more implementations.

FIG. 13 illustrates a schematic view of an example implementation of a locking system with a latch in an unlocked configuration and a striker of a container in an open configuration in accordance with one or more implementations.

FIG. 14 illustrates a schematic view of an example implementation of the locking system of FIG. 13 with the latch urged beyond the unlocked configuration and the striker of the container in an overtravel configuration in accordance with one or more implementations.

FIG. 15 illustrates a schematic view of an example implementation of a portion of the locking system of FIGS. 13 and 14 with the latch in a locked configuration and the striker of the container in a closed configuration in accordance with one or more implementations.

FIG. 16 illustrates a schematic view of an example implementation of the locking system of FIG. 13-15 with the latch urged beyond the locked configuration and the striker of the container in the overtravel configuration in accordance with one or more implementations.

FIG. 17 illustrates a schematic view of an example implementation of a portion of the locking system of FIGS. 13-16 with the latch in an open configuration and the striker of the container in the open configuration in accordance with one or more implementations.

FIGS. 18 illustrates a perspective view of an example implementation of a latch assembly having multiple latches in accordance with one or more implementations.

FIG. 19 illustrates a flow diagram of an example process for managing a locking system based on one or more detections in accordance with one or more implementations of the subject technology.

FIG. 20 illustrates a flow diagram of an example process for managing a locking system based on one or more detections in accordance with one or more implementations of the subject technology.

FIG. 21 illustrates a flow diagram of an example process for managing a locking system based on one or more detections in accordance with one or more implementations of the subject technology.

FIG. 22 illustrates a flow diagram of an example process for managing a locking system based on one or more profiles in accordance with one or more implementations of the subject technology.

FIG. 23 illustrates an electronic system with which one or more implementations of the subject technology may be implemented.

### SUMMARY

Embodiments of the present disclosure are directed toward a container management system that can use an electronic push-push interface to facilitate transition of the container in response to user inputs. Switches can be provided to detect the container position, and an actively controlled latch can respond to the detected position to lock or unlock the container. The display can also be operated to control the configuration of the container. The management system can also perform controls based on one or more other detectable conditions, such as locking the container when one or more external events are detected.

In accordance with aspects of the subject technology, an apparatus is provided that includes a container comprising a striker; a latch configured to transition between a locked configuration to retain the striker and an unlocked configuration to release the striker; and an actuator configured to: electronically actuate, in response to a detection that the latch is urged beyond the unlocked configuration, the latch to the locked configuration; and electronically actuate, in response to a detection that the latch is urged beyond the locked configuration, the latch to the unlocked configuration.

The latch may be configured to rotate to transition between the locked configuration and the unlocked configuration. The striker may be a first striker; the latch may be a first latch; the container further comprises a second striker; and the apparatus further comprises a second latch configured to transition between the locked configuration to retain the second striker and the unlocked configuration to release the second striker. The container may be configured to transition between an open configuration, a closed configuration, and an overtravel configuration, the closed configuration being between the open configuration and the overtravel configuration.

An ajar sensor may be configured to detect when the container is in the open configuration or the closed configuration. A bumper may be configured to bias the container from the closed configuration toward the open configuration and compress as the container extends beyond the closed configuration to an overtravel configuration. The actuator may be configured to: in response to a detection that the container is transitioned from the open configuration to the overtravel configuration, electronically actuate the latch to the locked configuration; and in response to a detection that the container is transitioned from the closed configuration to the overtravel configuration, electronically actuate the latch to the unlocked configuration.

The container may be a first container; the striker is a first striker; the latch is a first latch; the apparatus further comprises: a second container comprising a second striker; and a second latch configured to transition between the locked configuration to retain the second striker and the unlocked configuration to release the second striker. The actuator may be configured to electronically actuate both the first latch and the second latch to the locked configuration in response to a detection that either one of the first latch or the second latch is urged beyond the unlocked configuration; and electronically actuate both the first latch and the second latch to the unlocked configuration in response to a detection that either one of the first latch or the second latch is urged beyond the locked configuration.

In accordance with aspects of the subject technology, a vehicle is provided that includes a container configured to transition between an open configuration, a closed configuration, and an overtravel configuration, the closed configuration being between the open configuration and the overtravel configuration; an overtravel switch configured to detect when the container is in the overtravel configuration; and a latch configured to, in response to a detection by the overtravel switch, controllably transition between a locked configuration to retain the container in at least the closed configuration and an unlocked configuration to release the container to the open configuration.

An ajar sensor may be configured to detect when the container is in the open configuration or the closed configuration. A bumper may be configured to bias the container from the closed configuration toward the open configuration and compress as the container transitions from the closed configuration to the overtravel configuration. A striker may be connected to the container, wherein the latch is configured to rotate to engage the striker. A display device may be configured to detect a user input, wherein the latch is further configured to, in response to a detection of the user input, controllably transition to the unlocked configuration to release the container to the open configuration. A dashboard defining a recess may be provided for receiving the container and supporting the display device.

In accordance with aspects of the subject technology, a method is provided that includes detecting when a container is transitioned to an overtravel configuration from either an open configuration or a closed configuration of the container, the closed configuration being between the open configuration and the overtravel configuration; and in response to a detection that the container is in the overtravel configuration, controlling a latch to transition between a locked configuration to retain the container in at least the closed configuration and an unlocked configuration to release the container to the open configuration.

In response to a detection that the container is transitioned from the open configuration to the overtravel configuration, the latch may be controlled by transitioning the latch to the locked configuration. In response to a detection that the container is transitioned from the closed configuration to the overtravel configuration, the latch may be controlled by transitioning the latch to the unlocked configuration. Detecting when the container is transitioned to the overtravel configuration may include operating a switch. Detecting when the container is transitioned to the overtravel configuration may include detecting when the latch is urged beyond the unlocked configuration.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Embodiments of the present disclosure are directed toward a management system for a glove box or other container of a vehicle. Apparatuses, such as vehicles, buildings, and/or other enclosed and/or indoor spaces are often provided with containers, such as a glove box. Such containers can hold one or more items and transition between open and closed configurations.

Some push-push systems use mechanical parts, such as a combination of springs, pins, and slots, to achieve the desired motion profile. It can be desirable to provide actively controlled operations based on detected configuration of the container and/or the lock system. By providing a system with one or more switches to detect one or more configurations of the system, hardware components can be eliminated, and the container itself can be used as a mechanism for receiving user input. Electrical and/or other active control mechanisms allow integration of a variety of vehicle functions, such as event detection and various input capabilities.

The container management systems of the present disclosure can use an electronic push-push interface to facilitate transition of the container in response to user inputs. Switches can be provided to detect the container position, and an actively controlled latch can respond to the detected position to lock or unlock the container. The display can also be operated to control the configuration of the container. The management system can also perform controls based on one or more other detectable conditions, such as locking the container when an external event is detected.

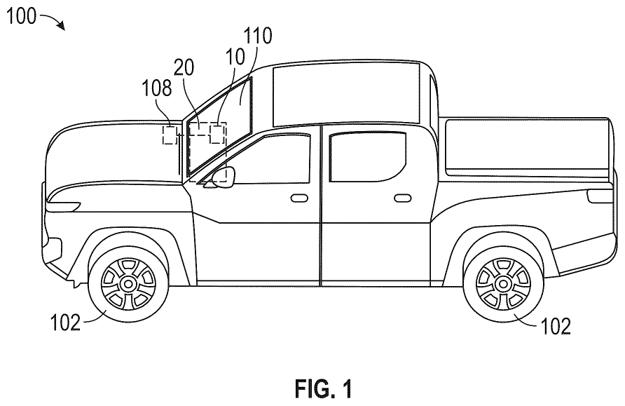

FIG. 1 is a diagram illustrating an example implementation of an apparatus as described herein. In the example of FIG. 1, the apparatus is a moveable apparatus implemented as a vehicle 100. In one or more implementations, the vehicle 100 may be implemented as an electric vehicle and may include one or more batteries for powering the vehicle and/or one or more systems and/or components of the vehicle.

For example, in one or more implementations, the vehicle 100 may be an electric vehicle having one or more electric motors that drive the wheels 102 of the vehicle using electric power from the battery. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid).

In the example of FIG. 1, the vehicle 100 is implemented as a truck (e.g., a pickup truck) having a dashboard 20 within a passenger compartment 110 of the vehicle 100. As shown, the dashboard 20 may provide or support a container system 10 with one or more containers that are disposed or otherwise accessible in a front portion of the passenger compartment 110, a rear portion of the passenger compartment 110, and/or other portions of the passenger compartment 110. As shown, the vehicle 100 may also include processing circuitry 108 (e.g., one or more processors, memory, and/or communications circuitry). The processing circuitry 108 may be communicatively coupled to the container system 10, for control, by the processing circuitry 108, of the container system 10 (e.g., to control a configuration of the containers of the container system 10).

As examples, the processing circuitry 108 of the vehicle 100 may include one or more processors (e.g., single processors, multi-core processors, central processing units (CPUs), application-specific integrated circuits (ASICS), field programmable gate arrays (FPGAs) and/or other processing circuits), and/or any of various types of computer-readable and/or machine- readable media (e.g., persistent storage, system memory and/or buffers, volatile memory and/or non-volatile memory). In one or more implementations, the processing circuitry 108 may include input devices, output devices, network interfaces, and/or a bus that communicatively couples the processor(s), the memory, the communications circuitry, the input devices, the output devices, and/or one or more other devices or components (e.g., container system 10, displays, cameras, motion sensors, proximity sensors, etc.). The processor(s) of the processing circuitry 108 may execute instructions stored in the memory of the processing circuitry 108, such as to execute hardware, firmware, and/or software processes in order to perform the processes of the subject disclosure.

The example of FIG. 1, in which the vehicle 100 is implemented as a pickup truck having a truck bed, is merely illustrative. In other implementations, the vehicle 100 may implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, and/or any other movable apparatus having a dashboard 20, a container system 10, and processing circuitry 108.

In one or more implementations, the container system 10 and/or processing circuitry 108 as described herein may also, or alternatively, be implemented in another apparatus, such as a building (e.g., a residential home or commercial building, or any other building) or other stationary apparatus.

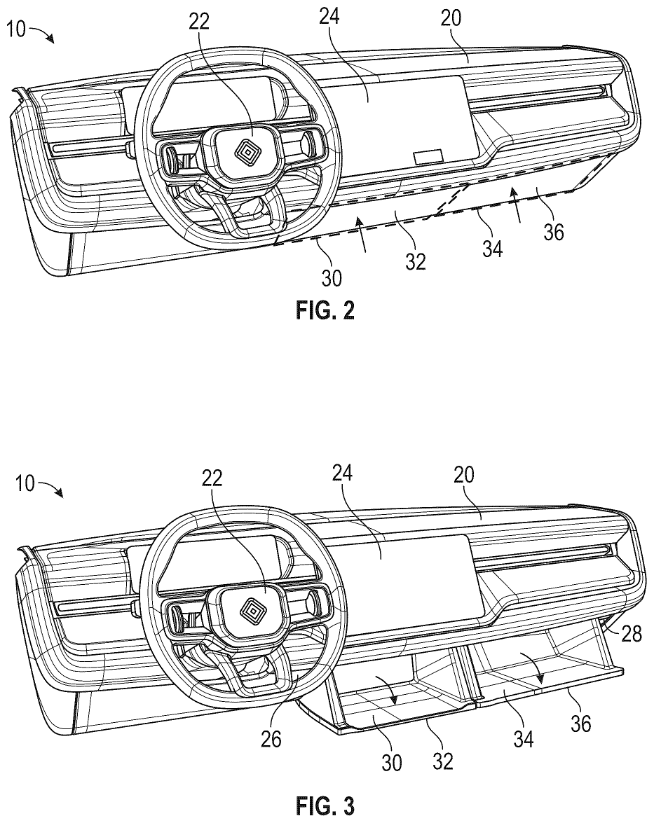

Referring now to FIGS. 2 and 3, a container system 10 can be located within a passenger compartment of a vehicle. As shown in FIG. 2, the vehicle can include a dashboard 20 that includes and/or supports one or more components, such as a steering wheel 22 and/or a display device 24 configured to detect a user input. In some embodiments, one or more containers 30 and 34 can be located along a dashboard 20 of the vehicle. For example, one or more containers 30 and 34 can be positioned at one or more sides of and/or beneath a steering wheel 22 and/or a display device 24 at the dashboard 20. In some embodiments, the one or more containers 30 and 34 can be aligned along a common side (e.g., underside) of the dashboard 20. In some embodiments, separate containers 30 and 34 can be positioned adjacent to each other.

As shown in FIG. 3, the dashboard 20 can define one or more recesses 26 and 28 for receiving the containers 30 and 34. Each of the containers 30 and 34 can transition between a closed configuration (FIG. 2) (e.g., within the recesses 26 and 28) and an open configuration (FIG. 3) (e.g., extending away from the dashboard 20). The container system 10 can controllably transition the containers 30 and 34 between the closed configuration and the open configuration in response to a user input. For example, the user input can be received at outer surfaces 32 and 36 of the containers 30 and 34, respectively. Such inputs can be a force or other actuation of the containers 30 and 34, which can be detected by the container system 10 as described further herein. By further example, the user input can be received at the display device 24. By further example, the container system 10 can controllably transition the containers 30 and 34 between the closed configuration and the open configuration in response to one or more detected conditions.

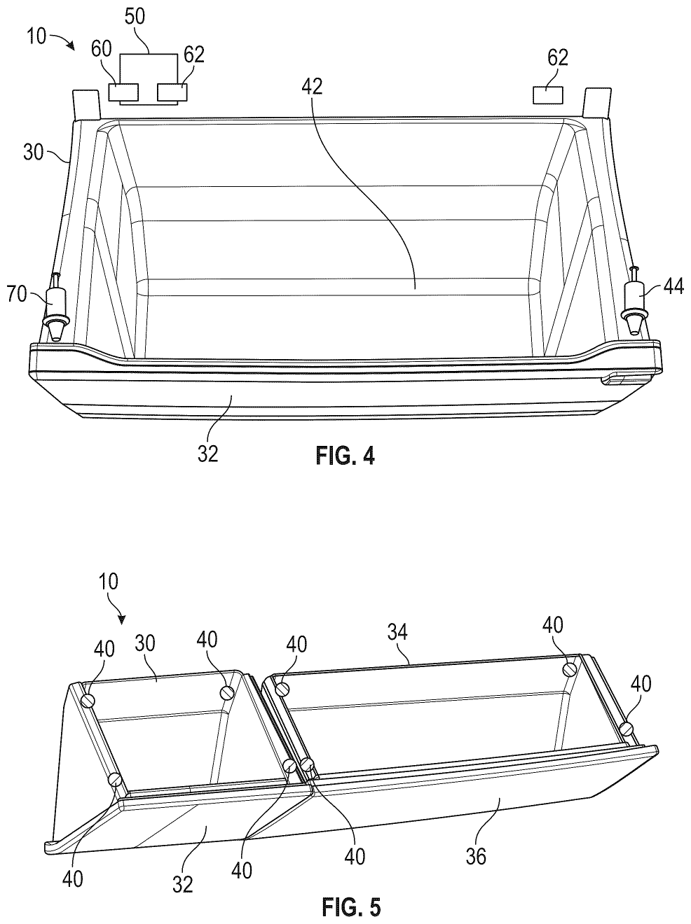

Referring now to FIG. 4, each container can include one or more features for facilitating transitions between different configurations. While only one container is shown in FIG. 4, it will be understood that one or more additional features illustrated in FIG. 4 can be applied to any one or more of the containers of the container system 10. As shown in FIG. 4, a container 30 can include an interior space 42 defined by one or more walls and/or the outer surface 32 of the container 30.

In some embodiments, the container system 10 can include a latch 50 for controllably engaging a portion of the container 30, such as a striker (not shown). While only one latch 50 is shown, it will be understood that multiple latches 50 can be provided for each container 30. Such multiple latches 50 can be controlled in concert.

In some embodiments, the container system 10 can include an overtravel switch 62 that is configured to detect a configuration of the container 30. For example, the overtravel switch 62 can detect whether the container is in an overtravel configuration, as described further herein. One or more of the overtravel switches 62 can be integrated with one or more latches 50 of the container system 10. In some embodiments, multiple overtravel switches 62 can be provided, for example at opposing lateral sides of the container 30. Accordingly, force inputs from a user applied to only one side of the container 30 can be detected by either one of the overtravel switches 62. It will be understood that only one overtravel switch 62 may be provided. For example, a single overtravel switch 62 can be integrated within latch 50 and/or with ajar sensor 60. Force inputs from a user applied to either side of the container 30 (e.g., not including an overtravel switch) can be transmitted to an opposing side of the container 30 (e.g., including the overtravel switch 62) such that the force input is detected by the single overtravel switch 62. For example, the opposing sides of the container 30 can be coupled together with a rigid structure (e.g., axle) such that a force and/or torque on one side of the container 30 results in corresponding motion on another (e.g., opposite) side of the container 30. In some embodiments, the overtravel switch 62 includes a proximity sensor, depth sensor, optical sensor, electromechanical switch (e.g., dome switch), and the like.

In some embodiments, the container system 10 can include an ajar sensor 60 configured to detect when the container 30 is in the open configuration or the closed configuration. For example, the ajar sensor 60 can detect the container 30 itself, regardless of whether it is engaged by a latch 50 or interacting with the overtravel switch 62. In some embodiments, the ajar sensor 60 can include a proximity sensor, depth sensor, optical sensor, electromechanical switch (e.g., dome switch), and the like.

In some embodiments, the container 30 and/or a structure supporting the container 30 (e.g., the dashboard) can include one or more bumpers 44 configured to bias the container 30 from the closed configuration toward the open configuration and compress as the container 30 extends beyond the closed configuration to an overtravel configuration. For example, the one or more bumpers 44 can be coupled to a dashboard and exposed to abut the container 30 in one or more configurations thereof. Such one or more bumpers 44 can also dampen vibrations applied to the container 30 and/or other structures coupled thereto, for example, while the container 30 is in the closed configuration.

Referring now to FIG. 5, the container system 10 can include one or more containers 30 and 34 that provide one or more mechanisms for engagement with a latch. As shown in FIG. 5, the containers 30 and 34 can include one or more strikers 40 or interacting with a latch of the container system 10. In some embodiments, multiple strikers 40 can be provided on opposing sides of each of the containers 30 and 34. In some embodiments, the strikers 40 can be provided on a rear side of each of the containers 30 and 34, wherein the rear side is opposite the outer surfaces 32 and 36. In some embodiments, the strikers 40 can be provided on an upper side of each of the containers 30 and 34, such as at an upper surface of walls surrounding the interior spaces of the containers 30 and 34. It will be understood that a variety of configurations for one or more strikers can be provided.

By providing multiple strikers 40 and corresponding latches, the containers 30 and 34 can be retained even when only one locking mechanism is able to secure. Where only one locking mechanism is able to secure, for example when an object obstructs at least a side of a container, such a locking mechanism can still be released when the user input is detected. Accordingly, the container can transition between open and closed configurations based on partial movement of the container to the overtravel configuration.

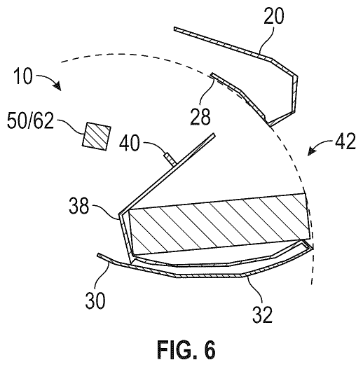

Referring now to FIGS. 6-8, a container can be transition between a variety of configurations with respect to other portions of the vehicle, such as a dashboard 20. While the transitions illustrated herein relate to rotational motion of the container 30, it will be understood that such transitions can relate to translational motion of a container 30 and/or combinations thereof.

As shown in FIG. 6, the container 30 can be provided in an open configuration, with an interior space 42 of the container 30 exposed to an interior of the vehicle and/or not covered by a portion of the dashboard 20. While in the open configuration, the container 30 can receive one or more items to be stored therein.

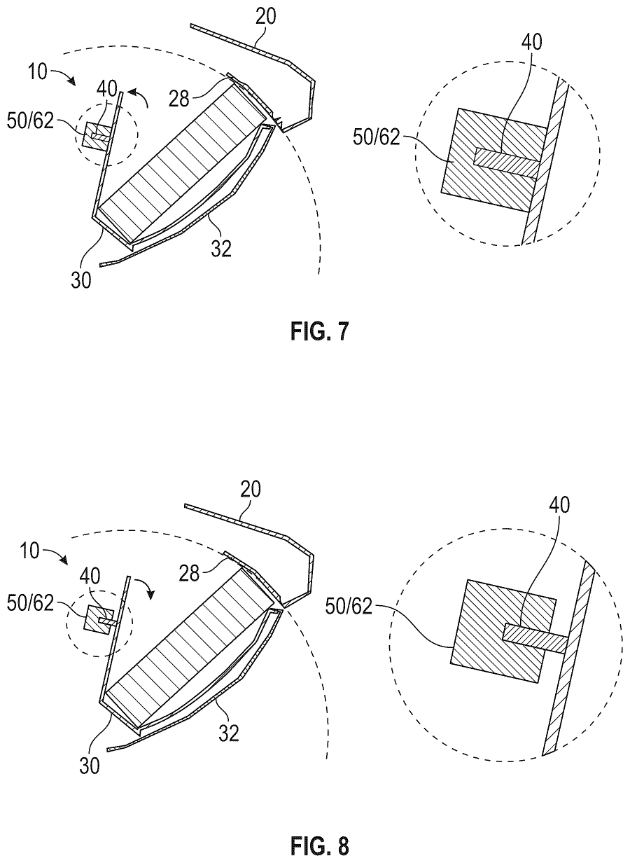

As shown in FIG. 7, the container 30 can be transitioned from the open configuration to an overtravel configuration. In some embodiments, the transition from the open configuration to one or more other configurations can be achieved based on a user input, such as a force applied to the outer surface 32 of the container 30. While in the overtravel configuration, the striker 40 or another portion of the container 30 can interact with a latch 50 and/or an overtravel switch 62. For example, the latch 50 can be configured to allow passage of the container 30 from the open configuration to the overtravel configuration. The overtravel switch 62 can include one or more features to detect the presence of the striker 40 and/or another portion of the container 30 while in the overtravel configuration. As such, the processing circuitry connected to and/or included with the container system 10 can detect when the container 30 is in the overtravel configuration. Where the container system 10 detects that the container 30 is transitioned from the open configuration to the overtravel configuration, the latch 50 can be operated to engage the striker 40 or another portion of a container 30.

As shown in FIG. 8, the container 30 can be transitioned from the overtravel configuration to a closed configuration, with the interior space 42 of the container 30 covered by a portion of the dashboard 20 and/or otherwise not exposed to an interior of the vehicle. In some embodiments, the transition from the overtravel configuration to one or more other configurations can be achieved of facilitated based on bumpers and/or other features of the container 30 and/or in the absence or removal of a user input. The latch 50 can be operated to engage the striker 40 and/or another portion of the container 30 to retain the container 30 in the closed configuration. Such retention can be maintained against other forces, such as from a bumper and/or the force of gravity. As shown, the closed configuration can be between the open configuration and the overtravel configuration along the path travelled by the container 30.

The container 30 can be transitioned from a closed configuration (FIG. 8) to the overtravel configuration (FIG. 7). In some embodiments, the transition from the closed configuration to one or more other configurations can be achieved based on a user input, such as a force applied to the outer surface 32 of the container 30. Where the container system 10 detects that the container 30 is transitioned from the closed configuration to the overtravel configuration, the latch 50 can be operated to disengage the striker 40 or another portion of a container 30. Accordingly, the container 30 can be permitted to transition to the open configuration (FIG. 6).

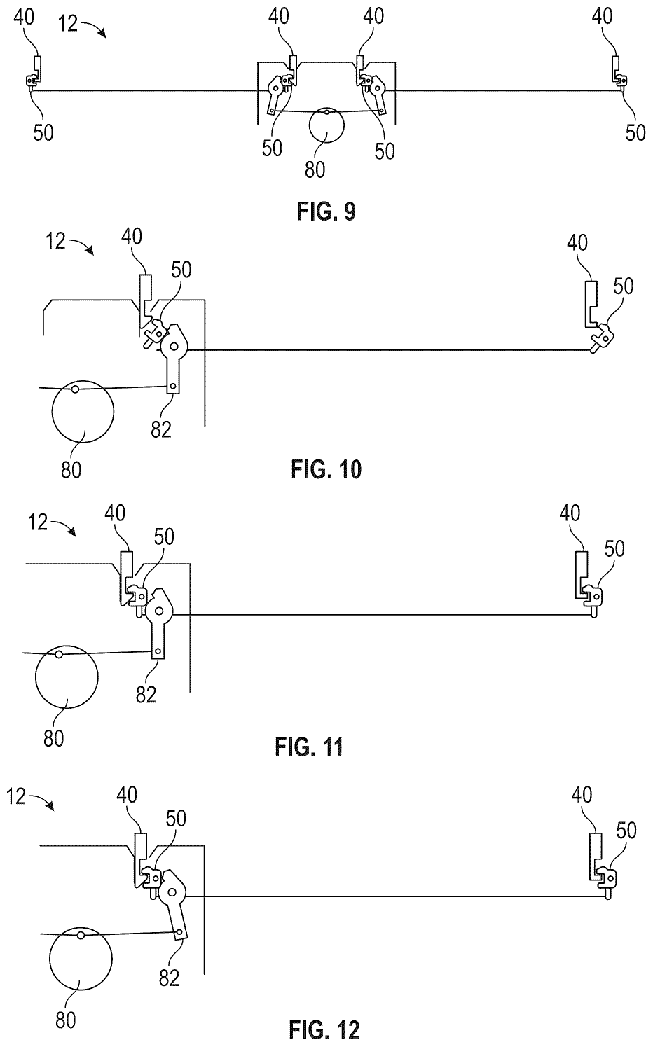

Referring now to FIGS. 9-12, an example of a lock system can include one or more latches that engage strikers of one or more containers. As shown in FIG. 9, a lock system 12 can include multiple latches 50, each configured to controllably engage or disengage a corresponding one of multiple strikers 40. The strikers 40 can be components of corresponding containers, where multiple strikers can be provided by any one container. In some embodiments, a single actuator 80 can be provided to control selective ones of the latches 50. The actuator 80 may include one or more devices for directly or indirectly moving and/or controlling the latches 50. The actuator 80 may be one or more types of actuators such as an electric, magnetic, mechanical, or any other type of actuator. The actuator 80 can include motors, hydraulic actuators, pneumatic actuators, magnetic actuators, piezoelectric actuators, electroactive materials, stepper motors, shape-memory alloys, and the like, as well as drivetrain components such as gears, clutches, and/or transmissions, to facilitate movement of the latches 50 based on operation of the actuator 80.

While the actuator 80 of FIGS. 9-12 is shown as a body for rotation (e.g., via a motor), it should be understood that the actuator 80 can be configured to move translationally (e.g., with or without rotation) to directly or indirectly move and/or control the latches 50. While

In some embodiments, the actuator 80 can be moved (e.g., rotated or translated) in a first direction to actuate one or more first latches 50, for example to controllably engage or disengage a first container. In some embodiments, the actuator 80 can be moved (e.g., rotated or translated) in a second direction to actuate one or more second latches 50, for example to controllably engage or disengage a second container. Accordingly, a single actuator 80 can optionally be provided for independent control of separate containers. Such an arrangement can reduce the number of parts and/or complexity of the overall system.

As shown in FIG. 10, one or more strikers 40 can be provided as engagement portions of a container. Each of the strikers 40 can be provided to a latch 50, which can each engage a corresponding one of the strikers 40 to retain the container in a closed configuration. In some embodiments, the latches 50 can be directly coupled to the actuator 80. In some embodiments, the latches 50 can be indirectly coupled to the actuator 80, for example by an intervening structure such as a pawl 82. In some embodiments, multiple latches 50 can be jointly connected to each other and/or one or more pawls 82 and/or the actuator 80. As such, the latches 50 can be moved in unison between a locked configuration, as shown in FIG. 10, and a unlocked configuration. In some embodiments, the latches 50 can be biased to a locked configuration and controllably actuated to an unlocked configuration. In some embodiments, the latches 50 can be biased to an unlocked configuration and controllably actuated to a locked configuration.

As shown in FIG. 11, the actuator 80 can be operated to control a pawl 82 and/or a latch 50. For example, the actuator 80 can be rotated and/or otherwise moved to apply a force to a pawl 82. In response, the pawl 82 can be transitioned away from the one or more latches 50. The operation of the actuator 80 can be performed in response to a detection that the container is in an overtravel configuration. Additionally or alternatively, the operation of the actuator 80 can be performed in response to a detection that an input is received at another input device of the vehicle, such as a display device. Additionally or alternatively, the operation of the actuator 80 can be prevented based on one or more detected conditions, as described further herein.

As shown in FIG. 12, the latches 50 can transition from a locked configuration to an unlocked configuration. With the pawl 82 in a disengage configuration, the latches 50 can be permitted to disengage from the strikers 40. For example, the latches 50 can be biased away from the strikers 40, such that disengagement of the pawl 82 can allow the latches 50 to move into the biased unlocked configuration. Additionally or alternatively, the actuator 80 can be operated, optionally with the pawl 82, to force the latches into the unlocked configuration against a biasing force. With the latches 50 and the unlocked configuration, the strikers 40 can be released and permitted to move away from the latches 50. Accordingly, the container can transition from the closed configuration to the open configuration.

The actuator 80 can be further operated to control a pawl 82 and/or a latch 50 in response to a further detection that the container is in an overtravel configuration. For example, when the strikers 40 and/or another portion of the container are returned (e.g., as detected by an overtravel switch), the latches 50 can be returned or maintained in a locked configuration.

While the pawl 82 of FIGS. 9-12 is shown as a body for rotation (e.g., by actuator 80), it should be understood that the pawl 82 can be configured to move translationally (e.g., with or without rotation) to selectively interact with the latches 50. In some embodiments, the pawl 82 includes a rigid structure that is configured to slide (e.g., in response to actuator 80). The pawl 82 can include one or more shapes and/or structures that, in a first configuration, prevent motion (e.g., rotation or translation) of the one or more latches 50 and that, in a second configuration, allow motion (e.g., rotation or translation) of the one or more latches 50, as described herein. For example, the pawl 82 can include one or more walls and one or more cutouts (e.g., recesses, openings, and the like), wherein the one or more walls can be aligned with the one or more latches 50 in the first configuration, and the one or more cutouts can be aligned with the one or more latches 50 in the second configuration.

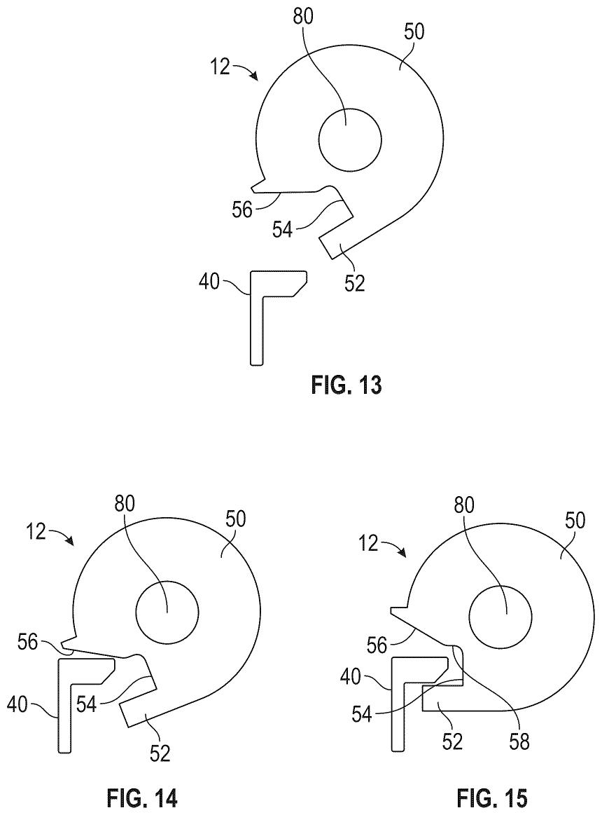

Referring now to FIGS. 13-18, an example of a lock system can include one or more latches that engage strikers of one or more containers. In some embodiments, an actuator 80 can be provided to control one or more latches 50. The actuator 80 may include one or more devices for directly or indirectly moving and/or controlling the latches 50. The actuator 80 may be one or more types of actuators such as an electric, magnetic, mechanical, or any other type of actuator. The actuator 80 can include motors, hydraulic actuators, pneumatic actuators, magnetic actuators, piezoelectric actuators, electroactive materials, stepper motors, shape-memory alloys, and the like, as well as drivetrain components such as gears, clutches, and/or transmissions, to facilitate movement of the latches 50 based on operation of the actuator 80. In some embodiments, the actuator 80 can move (e.g., rotate or translate) the latch 50, for example to controllably engage or disengage a first container.

As shown in FIG. 13, one or more strikers 40 can be provided as engagement portions of a container. The striker 40 can be provided to the latch 50, which can receive the striker 40 while in an unlocked configuration. In such a configuration, a protrusion 52 of the latch 50 can be positioned to allow a portion of the striker 40 to enter into a recess 54 of the latch 50.

As shown in FIG. 14, the lock system 12 can detect an overtravel configuration of the container. The striker 40 can be advanced as the container enters into an overtravel configuration thereof. For example, the striker 40 can abut a first engagement surface 56 of the latch 50. With the container into the overtravel configuration, the striker 40 can urge the latch 50 beyond the unlocked configuration by applying a force to the first engagement surface 56 of the latch 50. Such a force can be detected by the actuator 80 and/or another mechanism operating as an overtravel switch. The container system can receive and interpret such an event as a user input to retain the container in the closed configuration.

As shown in FIG. 15, the actuator 80 can be operated to control the latch 50. For example, the actuator 80 can rotate and/or otherwise move the latch 50 so that the protrusion 52 retains the striker 40. The operation of the actuator 80 can be performed in response to a detection that the container is in an overtravel configuration.

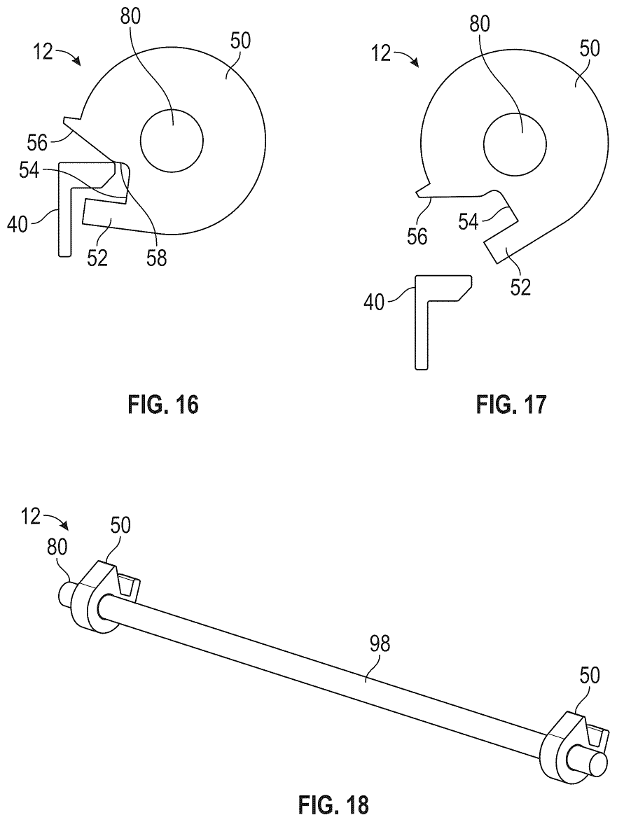

As shown in FIG. 16, the lock system 12 can detect another overtravel configuration of the container. The striker 40 can be advanced as the container enters into an overtravel configuration thereof. For example, the striker 40 can abut a second engagement surface 58 of the latch 50. With the container into the overtravel configuration, the striker 40 can urge the latch 50 beyond the locked configuration by applying a force to the second engagement surface 58 of the latch 50. Such a force can be detected by the actuator 80 and/or another mechanism operating as an overtravel switch. The container system can receive and interpret such an event as a user input to release the container to the open configuration.

As shown in FIG. 17, the latch 50 can transition from the locked configuration to an unlocked configuration. In such a configuration, the protrusion 52 of the latch 50 can be positioned to allow the striker 40 to move out of the recess 54 of the latch 50. The operation of the actuator 80 can be performed in response to a detection that the container is in an overtravel configuration. Additionally or alternatively, the operation of the actuator 80 can be performed in response to a detection that an input is received at another input device of the vehicle, such as a display device. Additionally or alternatively, the operation of the actuator 80 can be prevented based on one or more detected conditions, as described further herein.

As shown in FIG. 18, a lock system 12 can include multiple latches 50, each configured to controllably engage or disengage a corresponding one of multiple strikers. In some embodiments, a single actuator 80 can be provided to control multiple latches 50, which can be connected to each other by a common axle 98. In some embodiments, the multiple latches 50 can be configured to engage strikers on opposing sides of a given container.

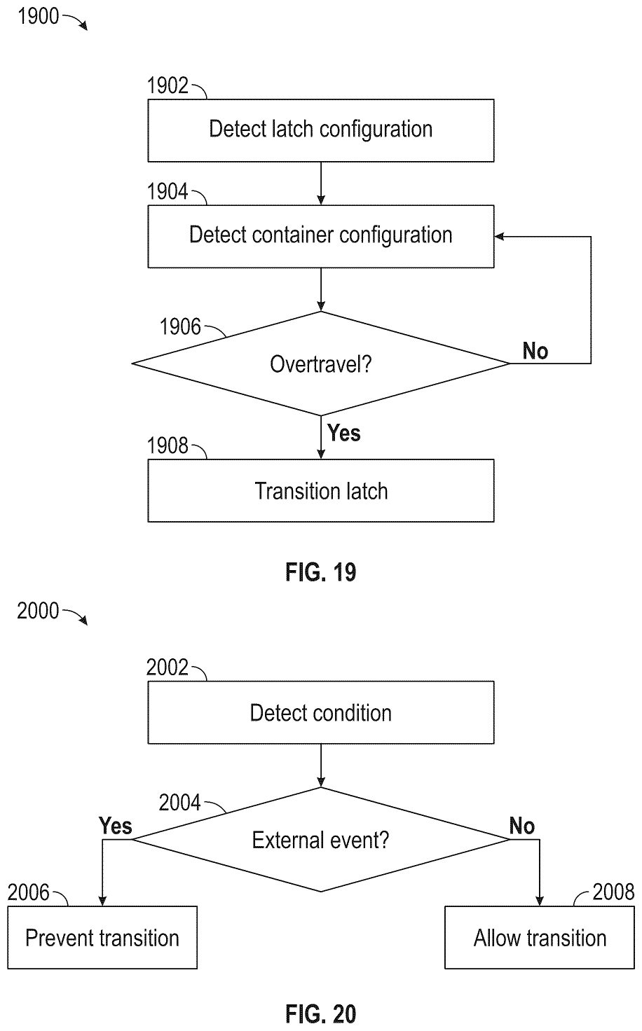

FIG. 19 illustrates a flow diagram of an example process 1900 for managing actuation of a lock system for a container in response to a user input in accordance with one or more implementations of the subject technology. For explanatory purposes, the process 1900 is primarily described herein with reference to the vehicle 100, container system 10, and/or lock system 12 of FIGS. 1-18, and/or various components thereof. However, the process 1900 is not limited to the vehicle 100, container system 10, and/or lock system 12 of FIGS. 1-18, and one or more blocks (or operations) of the process 1900 may be performed by one or more other structural components of the vehicle 100 and/or of other suitable moveable apparatuses, devices, or systems. Further, for explanatory purposes, some of the blocks of the process 1900 are described herein as occurring in serial, or linearly. However, multiple blocks of the process 1900 may occur in parallel. In addition, the blocks of the process 1900 need not be performed in the order shown and/or one or more blocks of the process 1900 need not be performed and/or can be replaced by other operations.

At block 1902, a vehicle can detect a latch configuration. In some embodiments, one or more latches can be in either a locked configuration or an unlocked configuration.

At block 1904, the vehicle can detect a container configuration. In some embodiments, one or more containers can be in either an open configuration, a close configuration, or an overtravel configuration. In some embodiments, detecting whether the container is in an open configuration can include operating an ajar sensor. In some embodiments, detecting whether the container is in an overtravel configuration can include operating an overtravel switch. In some embodiments, detecting whether the container is in an overtravel configuration can include operating an actuator of a latch.

At block 1906, if the vehicle detects that the container is in the overtravel configuration, the process 1900 can proceed to block 1908. If the vehicle detects that the container is not in the overtravel configuration, the process 1900 can return to block 1904 and/or another block and/or process.

At block 1908, the vehicle can transition a latch between a locked configuration and an unlocked configuration. In some embodiments, the latch can be transitioned to the locked configuration in response to a detection that the container is in the overtravel configuration while the latch is in the unlocked configuration. In some embodiments, the latch can be transitioned to the locked configuration in response to a detection that the container was transitioned from the open configuration to the overtravel configuration. In some embodiments, the latch can be transitioned to the unlocked configuration in response to a detection that the container is in the overtravel configuration while the latch is in the locked configuration. In some embodiments, the latch can be transitioned to the unlocked configuration in response to a detection that the container was transitioned from the closed configuration to the overtravel configuration.

Following block 1908, the process 1900 can return to block 1902 and/or another block and/or process.

FIG. 20 illustrates a flow diagram of an example process 2000 for managing actuation of a lock system for a container in accordance with one or more implementations of the subject technology. For explanatory purposes, the process 2000 is primarily described herein with reference to the vehicle 100, container system 10, and/or lock system 12 of FIGS. 1-18, and/or various components thereof. However, the process 2000 is not limited to the vehicle 100, container system 10, and/or lock system 12 of FIGS. 1-18, and one or more blocks (or operations) of the process 2000 may be performed by one or more other structural components of the vehicle 100 and/or of other suitable moveable apparatuses, devices, or systems. Further, for explanatory purposes, some of the blocks of the process 2000 are described herein as occurring in serial, or linearly. However, multiple blocks of the process 2000 may occur in parallel. In addition, the blocks of the process 2000 need not be performed in the order shown and/or one or more blocks of the process 2000 need not be performed and/or can be replaced by other operations.

At block 2002, a vehicle can detect one or more conditions. For example, the one or more conditions can relate to a condition of the vehicle and/or an external environment. By further example, the one or more conditions can relate to a condition apart from a container, container system, and/or lock system. In some embodiments, the vehicle can include one or more sensors, such as accelerometers and the like. The vehicle can detect its motion and/or changes to the motion of the vehicle. For example, the vehicle can detect an acceleration or other changes to speed and/or direction of the vehicle. Such detections can form a basis for further operations.

At block 2004, the detected condition can be evaluated to determine whether it qualifies as an external event. In some embodiments, certain external events can be determined and the vehicle can modify the operation of a container system and/or lock system in response. In some embodiments, the detected condition can be an acceleration, a location, a presence of an object (e.g., outside the vehicle), a detected movement of the vehicle, a change in a movement of the vehicle, a user input, combinations thereof, and the like. In some embodiments, the detected condition can be compared to a threshold to determine whether it exceeds or does not exceed the threshold. Where one or more thresholds are exceeded, the vehicle can determine that an external event has occurred, and the process can proceed to block 2006. Where one or more thresholds are not exceeded, the vehicle can determine that an external event has not occurred, and the process can proceed to block 2008.

At block 2006, the vehicle can prevent transition of a container of a container system and/or a latch of a lock system. For example, where an external event is determined to have occurred and/or one or more detected conditions satisfy one or more thresholds, the vehicle can prevent transition of a container and/or latch regardless of user inputs that have been detected. By further example, a force applied to a container may otherwise be determined to be a user input where such a force transitions the container to an overtravel configuration. However, where an external event is determined to have occurred, such a force can be interpreted as other than a user input. By further example, such a force can be attributed to an unintentional contact with the container where certain external offense are determined to have occurred. As such, transition of the container can be prevented and the container can be retained in the closed configuration. By further example, transition of the latch can be prevented and the latch can be retained in the locked configuration. As such, a process such as process 1900 can be prevented or overridden under certain circumstances.

At block 2008, the vehicle can allow transition of a container of a container system and/or a latch of a lock system. For example, where an external event is determined to have not occurred and/or one or more detected conditions do not satisfy one or more thresholds, the vehicle can allow transition of a container and/or latch in response to user inputs that have been detected. For example, at block 2008, a process such as process 1900 can be permitted.

Following block 2006 and/or 2008, the process 2000 can return to block 2002 and/or another block and/or process.

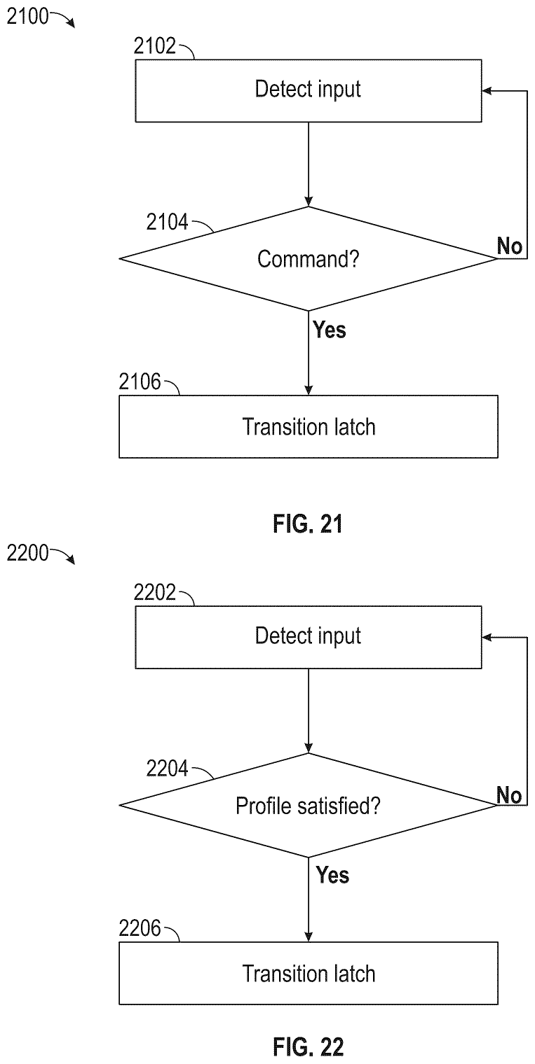

FIG. 21 illustrates a flow diagram of an example process 2100 for managing actuation of a lock system for a container in response to a user input in accordance with one or more implementations of the subject technology. For explanatory purposes, the process 2100 is primarily described herein with reference to the vehicle 100, container system 10, and/or lock system 12 of FIGS. 1-18, and/or various components thereof. However, the process 2100 is not limited to the vehicle 100, container system 10, and/or lock system 12 of FIGS. 1-18, and one or more blocks (or operations) of the process 2100 may be performed by one or more other structural components of the vehicle 100 and/or of other suitable moveable apparatuses, devices, or systems. Further, for explanatory purposes, some of the blocks of the process 2100 are described herein as occurring in serial, or linearly. However, multiple blocks of the process 2100 may occur in parallel. In addition, the blocks of the process 2100 need not be performed in the order shown and/or one or more blocks of the process 2100 need not be performed and/or can be replaced by other operations.

At block 2102, a vehicle can detect an input. In some embodiments, the input can be detected by a display device. For example, the display device can include a touch sensitive surface that is configured to receive touch or other input from a user. In some embodiments, the input can be detected at another input device. In some embodiments, the input can be detected by a microphone, a touchpad, a keyboard, a button, an external device in communication with the vehicle, and the like.

At block 2104, the vehicle determines whether the input defines a command to transition a latch. In some embodiments, if the vehicle detects that the input satisfies one or more criteria, the process 2100 can proceed to block 2106. For example, if the container is in the overtravel configuration, then the vehicle can determine that the input defines a command to transition the latch. In some embodiments, if the vehicle detects that the input does not satisfy one or more criteria, the process 2100 can return to block 2102 and/or another block and/or process. For example, if the container is not in the overtravel configuration, then the vehicle can determine that the input does not define a command to transition the latch.

At block 2106, the vehicle can transition a latch between a locked configuration and an unlocked configuration. In some embodiments, the latch can be transitioned to the unlocked configuration in response to a detection that the container is in the closed configuration while the input is received.

Following block 2106, the process 2100 can return to block 2102 and/or another block and/or process.

FIG. 22 illustrates a flow diagram of an example process 2200 for managing actuation of a lock system for a container in response to a user identification and/or user profile in accordance with one or more implementations of the subject technology. For explanatory purposes, the process 2200 is primarily described herein with reference to the vehicle 100, container system 10, and/or lock system 12 of FIGS. 1-18, and/or various components thereof. However, the process 2200 is not limited to the vehicle 100, container system 10, and/or lock system 12 of FIGS. 1-18, and one or more blocks (or operations) of the process 2200 may be performed by one or more other structural components of the vehicle 100 and/or of other suitable moveable apparatuses, devices, or systems. Further, for explanatory purposes, some of the blocks of the process 2200 are described herein as occurring in serial, or linearly. However, multiple blocks of the process 2200 may occur in parallel. In addition, the blocks of the process 2200 need not be performed in the order shown and/or one or more blocks of the process 2200 need not be performed and/or can be replaced by other operations.

At block 2202, a vehicle can detect an input. In some embodiments, the input can be detected by a display device. For example, the display device can include a touch sensitive surface that is configured to receive touch or other input from a user. In some embodiments, the input can be detected at another input device. In some embodiments, the input can be detected by a microphone, a touchpad, a keyboard, a button, an external device in communication with the vehicle, and the like.

At block 2204, the vehicle determines whether the input and/or a detected condition satisfies a profile (e.g., an active profile). The profile can be selected (e.g., set) by a user to be active (e.g., granting access and/or privileges). For example, one or more selected users can be granted access to one or more gloveboxes by being associated with a profile that is an active profile. Users not corresponding to at least one active profile may be prohibited access to the one or more gloveboxes. In some embodiments, if the vehicle detects that the input is received from a user, the vehicle can identify the user and determine whether the user satisfies one or more criteria, such as whether the user is associated with an active profile. If the vehicle determines that the user satisfies the active profile, the process 2200 can proceed to block 2206. In some embodiments, if the vehicle determines that the user does not satisfy the one or more criteria, such as that the user is not associated with an active profile and/or is associated with a profile that is inactive and/or is prohibited access and/or privileges, the process 2200 can return to block 2202 and/or another block and/or process.

At block 2206, the vehicle can transition a latch between a locked configuration and an unlocked configuration. In some embodiments, the latch can be transitioned to the unlocked configuration in response to a detection that the profile is satisfied while the input is received.

Following block 2206, the process 2200 can return to block 2202 and/or another block and/or process.

By providing a requirement that a profile is to be satisfied, the user can select who is granted access to one or more gloveboxes. Accordingly, a user can designate other users and whether they are granted or prohibited access. The user can also change the active profiles to prevent one or more users (e.g., identified or unidentified users) from gaining access to the one or more gloveboxes. For example, an active profile can include a mode in which unidentified users (e.g., guests) are prohibited access to the one or more gloveboxes. Accordingly, inputs from such guests may not cause or result in the one or more gloveboxes being opened (e.g., transitioning the latches).

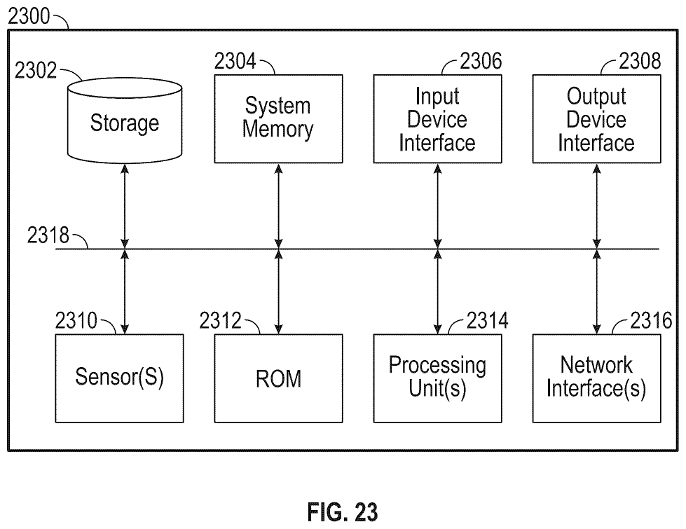

FIG. 23 illustrates an example electronic system 2300 with which aspects of the present disclosure may be implemented. The electronic system 2300 can be, and/or can be a part of, any electronic device for providing the features and performing processes described in reference to FIGS. 1-22, including but not limited to a vehicle, computer, server, smartphone, and wearable device (e.g., authentication device). The electronic system 2300 may include various types of computer-readable media and interfaces for various other types of computer-readable media. The electronic system 2300 includes a persistent storage device 2302, system memory 2304 (and/or buffer), input device interface 2306, output device interface 2308, sensor(s) 2310, ROM 2312, processing unit(s) 2314, network interface 2316, bus 2318, and/or subsets and variations thereof.

The bus 2318 collectively represents all system, peripheral, and chipset buses that communicatively connect the numerous internal devices and/or components of the electronic system 2300, such as any of the components of the vehicle 100 discussed above with respect to FIG. 1. In one or more implementations, the bus 2318 communicatively connects the one or more processing unit(s) 2314 with the ROM 2312, the system memory 2304, and the persistent storage device 2302. From these various memory units, the one or more processing unit(s) 2314 retrieves instructions to execute and data to process in order to execute the processes of the subject disclosure. The one or more processing unit(s) 2314 can be a single processor or a multi-core processor in different implementations. In one or more implementations, one or more of the processing unit(s) 2314 may be included in a container system, such as in the form of the processing circuitry 108.

The ROM 2312 stores static data and instructions that are needed by the one or more processing unit(s) 2314 and other modules of the electronic system 2300. The persistent storage device 2302, on the other hand, may be a read-and-write memory device. The persistent storage device 2302 may be a non-volatile memory unit that stores instructions and data even when the electronic system 2300 is off. In one or more implementations, a mass-storage device (such as a magnetic or optical disk and its corresponding disk drive) may be used as the persistent storage device 2302.

In one or more implementations, a removable storage device (such as a floppy disk, flash drive, and its corresponding disk drive) may be used as the persistent storage device 2302. Like the persistent storage device 2302, the system memory 2304 may be a read-and-write memory device. However, unlike the persistent storage device 2302, the system memory 2304 may be a volatile read-and-write memory, such as RAM. The system memory 2304 may store any of the instructions and data that one or more processing unit(s) 2314 may need at runtime. In one or more implementations, the processes of the subject disclosure are stored in the system memory 2304, the persistent storage device 2302, and/or the ROM 2312. From these various memory units, the one or more processing unit(s) 2314 retrieves instructions to execute and data to process in order to execute the processes of one or more implementations.

The persistent storage device 2302 and/or the system memory 2304 may include one or more machine learning models. Machine learning models, such as those described herein, are often used to form predictions, solve problems, recognize objects in image data, and the like. For example, machine learning models described herein may be used to predict whether an authorized user is approaching a vehicle and intends to open a charging port closure. Various implementations of the machine learning model are possible. For example, the machine learning model may be a deep learning network, a transformer-based model (or other attention-based models), a multi-layer perceptron or other feed-forward networks, neural networks, and the like. In various examples, machine learning models may be more adaptable as machine learning models may be improved over time by re-training the models as additional data becomes available.

The bus 2318 also connects to the input device interfaces 2306 and output device interfaces 2308. The input device interface 2306 enables a user to communicate information and select commands to the electronic system 2300. Input devices that may be used with the input device interface 2306 may include, for example, alphanumeric keyboards, touch screens, and pointing devices. The output device interface 2308 may enable the electronic system 2300 to communicate information to users. For example, the output device interface 2308 may provide the display of images generated by electronic system 2300. Output devices that may be used with the output device interface 2308 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 2318 also connects to sensor(s) 2310. The sensor(s) 2310 may include a location sensor, which may be used in determining device position based on positioning technology. For example, the location sensor may provide for one or more of GNSS positioning, wireless access point positioning, cellular phone signal positioning, Bluetooth signal positioning, image recognition positioning, and/or an inertial navigation system (e.g., via motion sensors such as an accelerometer and/or gyroscope). In one or more implementations, the sensor(s) 2310 may be utilized to detect movement, travel, and orientation of the electronic system 2300. For example, the sensor(s) may include an accelerometer, a rate gyroscope, and/or other motion-based sensor(s). The sensor(s) 2310 may include one or more biometric sensors and/or image sensors for authenticating a user.

The bus 2318 also couples the electronic system 2300 to one or more networks and/or to one or more network nodes through the one or more network interface(s) 2316. In this manner, the electronic system 2300 can be a part of a network of computers (such as a local area network or a wide area network). Any or all components of the electronic system 2300 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim clement is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. An apparatus comprising:
a container comprising a striker;
a latch configured to transition between a locked configuration to retain the striker and an unlocked configuration to release the striker; and
an actuator configured to:
electronically actuate, in response to a detection that the latch is urged beyond the unlocked configuration, the latch to the locked configuration; and
electronically actuate, in response to a detection that the latch is urged beyond the locked configuration, the latch to the unlocked configuration.

2. The apparatus of claim 1, wherein the latch is configured to rotate to transition between the locked configuration and the unlocked configuration.

3. The apparatus of claim 1, wherein:
the striker is a first striker;
the latch is a first latch;
the container further comprises a second striker; and
the apparatus further comprises a second latch configured to transition between the locked configuration to retain the second striker and the unlocked configuration to release the second striker.

4. The apparatus of claim 1, wherein the container is configured to transition between an open configuration, a closed configuration, and an overtravel configuration, the closed configuration being between the open configuration and the overtravel configuration.

5. The apparatus of claim 4, further comprising an ajar sensor configured to detect when the container is in the open configuration or the closed configuration.

6. The apparatus of claim 4, further comprising a bumper configured to bias the container from the closed configuration toward the open configuration and compress as the container extends beyond the closed configuration to the overtravel configuration.

7. The apparatus of claim 4, wherein the actuator is configured to:
in response to a detection that the container is transitioned from the open configuration to the overtravel configuration, electronically actuate the latch to the locked configuration; and
in response to a detection that the container is transitioned from the closed configuration to the overtravel configuration, electronically actuate the latch to the unlocked configuration.

8. The apparatus of claim 1, wherein:
the container is a first container;
the striker is a first striker;
the latch is a first latch;
the apparatus further comprises:
a second container comprising a second striker; and
a second latch configured to transition between the locked configuration to retain the second striker and the unlocked configuration to release the second striker.

9. The apparatus of claim 8, wherein the actuator is configured to:
electronically actuate both the first latch and the second latch to the locked configuration in response to a detection that either one of the first latch or the second latch is urged beyond the unlocked configuration; and
electronically actuate both the first latch and the second latch to the unlocked configuration in response to a detection that either one of the first latch or the second latch is urged beyond the locked configuration.

10. A vehicle comprising:
a container configured to transition between an open configuration, a closed configuration, and an overtravel configuration, the closed configuration being between the open configuration and the overtravel configuration;
an overtravel switch configured to detect when the container is in the overtravel configuration; and
a latch configured to, in response to a detection by the overtravel switch, controllably transition between a locked configuration to retain the container in at least the closed configuration and an unlocked configuration to release the container to the open configuration.

11. The vehicle of claim 10, further comprising an ajar sensor configured to detect when the container is in the open configuration or the closed configuration.

12. The vehicle of claim 10, further comprising a bumper configured to bias the container from the closed configuration toward the open configuration and compress as the container transitions from the closed configuration to the overtravel configuration.

13. The vehicle of claim 10, further comprising a striker connected to the container, wherein the latch is configured to rotate to engage the striker.

14. The vehicle of claim 10, further comprising a display device configured to detect a user input, wherein the latch is further configured to, in response to a detection of the user input, controllably transition to the unlocked configuration to release the container to the open configuration.

15. The vehicle of claim 14, further comprising a dashboard defining a recess for receiving the container and supporting the display device.

16. A method comprising:
detecting when a container is transitioned to an overtravel configuration from either an open configuration or a closed configuration of the container, the closed configuration being between the open configuration and the overtravel configuration; and
in response to a detection that the container is in the overtravel configuration, controlling a latch to transition between a locked configuration to retain the container in at least the closed configuration and an unlocked configuration to release the container to the open configuration.

17. The method of claim 16, wherein, in response to a detection that the container is transitioned from the open configuration to the overtravel configuration, controlling the latch comprises transitioning the latch to the locked configuration.

18. The method of claim 16, wherein, in response to a detection that the container is transitioned from the closed configuration to the overtravel configuration, controlling the latch comprises transitioning the latch to the unlocked configuration.

19. The method of claim 16, wherein detecting when the container is transitioned to the overtravel configuration comprises operating a switch. 20 The method of claim 16, wherein detecting when the container is transitioned to the overtravel configuration comprises detecting when the latch is urged beyond the unlocked configuration.
